(19) United States
(12) Patent Application Publication
(10) Pub. No.: US 2025/0239147 A1
(43) Pub. Date: Jul. 24, 2025

(54) DISASTER WARNING SYSTEM

(71) Applicant: HYOJITO CO., LTD., Nagoga-shi (JP)

(72) Inventor: Mitsuyoshi SASAKI, Nagoya-shi (JP)

(73) Assignee: HYOJITO CO., LTD., Nagoya-shi (JP)

(21) Appl. No.: 19/172,015

(22) Filed: Apr. 7, 2025

Related U.S. Application Data
(63) Continuation of application No. PCT/JP2023/032424, filed on Sep. 5, 2023.

(30) Foreign Application Priority Data
Oct. 13, 2022 (JP) 2022-164956

(51) Int. Cl. G08B 21/10; H04W 4/90

(52) U.S. Cl. CPC G08B 21/10; H04W 4/90

(57) ABSTRACT

A disaster warning system has a plurality of evacuation guidance signboard poles and a central server which manages operations of the evacuation guidance signboard poles. An operator uses an operation terminal to operate the disaster warning system and change statuses as appropriate. At every predetermined timings, each of the evacuation guidance signboard poles accesses the central server and receives a status by a communication unit of a control unit, and performs an operation based on the received status.

### CROSS REFERENCE TO RELATED APPLICATION

This application is a Continuation of International Application No. PCT/JP2023/032424, filed on Sep. 5, 2023, which claims the benefit of Japanese Patent Application Number 2022-164956 filed on Oct. 13, 2022, the disclosures of which are incorporated by reference herein in their entireties.

### FIELD OF THE INVENTION

The disclosure relates to a disaster warning system that performs evacuation guidance for evacuees in the case of a disaster by an evacuation guidance signboard pole including a warning device.

### BACKGROUND OF THE INVENTION

In a known disaster warning system, signals or the like are sequentially transmitted to warning devices so as to activate the warning devices.

For example, a disaster warning system described in JP 2004-288132 A includes a warning transmission device installed on a communication headquarters side and including a radiotelephone transmitter, and a plurality of warning reception devices installed on safety place sides and including radiotelephone receivers having respective telephone numbers different from one another. The warning transmission device utilizes a radiotelephone network to individually call the warning reception devices located on the safety place sides in an area in which a disaster has occurred, and transmit reporting messages corresponding to the respective safety places. Furthermore, each of the warning reception devices is configured to include a unit for causing an electric bulletin board to display the corresponding reporting message received via the radiotelephone receiver thereof.

However, in the above disaster warning system, the warning reception devices need to be individually called, and the respective reporting messages need to be transmitted thereto. Consequently, activation takes time as a whole. Thus, an issue arises in that evacuation guidance is delayed particularly in a warning reception device activated later in the order of activation. In addition, an issue arises also in that the activation time deviates among the plurality of warning reception devices.

An object of the disclosure is to provide a disaster warning system in which the activation time of the entirety of the warning system is shortened to perform swift evacuation guidance, and the deviation in activation time among a plurality of warning devices is decreased.

### SUMMARY OF THE INVENTION

In order to achieve the above object, a disaster warning system according to the disclosure as in a first aspect is a disaster warning system including a plurality of evacuation guidance signboard poles and a central server configured to manage the plurality of evacuation guidance signboard poles. The disaster warning system is configured to perform evacuation guidance for a disaster victim by the evacuation guidance signboard poles and the central server when a disaster occurs. Each of the evacuation guidance signboard poles includes a warning device configured to announce occurrence of the disaster with use of at least one of sound and light, and a control unit configured to control the evacuation guidance signboard pole. The control unit of each of the evacuation guidance signboard poles can control the warning device included in the evacuation guidance signboard pole to which the control unit belongs, and can communicate with the central server. The control unit performs its predetermined communication for accessing the central server at every predetermined timing, and performs the predetermined communication in a state where the evacuation guidance signboard poles are synchronized with one another. At the same time, the control unit reads its status managed by the central server. The status for each of the control units includes a warning status according to which an operation of the warning device is determined. The warning status for each of the control units makes it possible to arbitrarily set whether to stop or activate the warning device. When a disaster occurs, the warning status is set to activation. Thus, when the control unit of each of the evacuation guidance signboard pole receives the status through the predetermined communication and the warning status of the received status is activation, the control unit causes the warning device to perform an announcement operation.

In addition, a disaster warning system according to the disclosure as in a second aspect is a disaster warning system including an evacuation guidance signboard pole capable of communicating with a central server. The disaster warning system is configured to perform evacuation guidance for a disaster victim by the evacuation guidance signboard pole when a disaster occurs. The evacuation guidance signboard pole includes a warning device configured to announce occurrence of the disaster with use of at least one of sound and light, and a control unit configured to control the evacuation guidance signboard pole. The control unit can control the warning device included in the evacuation guidance signboard pole and can communicate with the central server configured to give an operation instruction for the control unit. The control unit performs its predetermined communication for accessing the central server at every predetermined timing, and reads its status managed by the central server. The status includes a warning status according to which an operation of the warning device is determined. The warning status makes it possible to arbitrarily set whether to stop or activate the warning device. When the control unit receives the status through the predetermined communication and the warning status is activation, the control unit causes the warning device to perform an announcement operation.

In addition, in the disclosure as in a third aspect based on the disaster warning system according to the first aspect, the evacuation guidance signboard pole includes an indication board indicating, for the disaster victim, a safety place and a disaster that can be covered.

In the disclosure as in a fourth aspect based on the disaster warning system according to the second aspect, the evacuation guidance signboard pole includes an indication board indicating, for the disaster victim, a safety place and a disaster that can be covered.

In addition, in the disclosure as in a fifth aspect based on the disaster warning system according to the first aspect, the warning status is set to stoppage in a normal state and when the disaster has ceased, so that the control unit stops the warning device when the control unit receives the status through the predetermined communication and the warning status is stoppage.

In the disclosure as in a sixth aspect based on the disaster warning system according to the second aspect, the warning status is set to stoppage in a normal state and when the disaster has ceased, so that the control unit stops the warning device when the control unit receives the status through the predetermined communication and the warning status is stoppage.

In addition, in the disclosure as in a seventh aspect based on the disaster warning system according to the first aspect, the warning device performs announcement with use of sound, the control unit includes a storage unit in which messages to be reproduced at a time of causing the warning device to perform the announcement operation are saved. The control unit assigns message identification information to each of the messages and manages the message. The status further includes the message identification information. The control unit receives the status through the predetermined communication so as to acquire the warning status and the message identification information. When the acquired warning status is set to activation, the control unit causes the warning device to perform the announcement operation so as to reproduce the message corresponding to the message identification information.

In the disclosure as in an eighth aspect based on the disaster warning system according to the second aspect, the warning device performs announcement with use of sound, the control unit includes a storage unit in which messages to be reproduced at a time of causing the warning device to perform the announcement operation are saved. The control unit assigns message identification information to each of the messages and manages the message. The status further includes the message identification information. The control unit receives the status through the predetermined communication so as to acquire the warning status and the message identification information. When the acquired warning status is set to activation, the control unit causes the warning device to perform the announcement operation so as to reproduce the message corresponding to the message identification information.

In addition, in the disclosure as in a ninth aspect based on the disaster warning system according to the seventh aspect, the message can be subjected to at least one of addition, change, and deletion through communication with the central server.

In the disclosure as in a tenth aspect based on the disaster warning system according to the eighth aspect, the message can be subjected to at least one of addition, change, and deletion through communication with the central server.

In addition, in the disclosure as in an eleventh aspect based on the disaster warning system according to the first aspect, the control unit includes a clock configured to measure the predetermined timings for the predetermined communication, and the clock is synchronized to keep accurate time through at least one of communication with an NTP server via the Internet and access to the central server.

In the disclosure as in a twelfth aspect based on the disaster warning system according to the second aspect, the control unit includes a clock configured to measure the predetermined timings for the predetermined communication, and the clock is synchronized to keep accurate time through at least one of communication with an NTP server via the Internet and access to the central server.

In addition, in the disclosure as in a thirteenth aspect based on the disaster warning system according to the eleventh aspect, the clock includes a battery configured to, when supply of power is interrupted owing to disconnection of a power supply, supply power instead.

In the disclosure as in a fourteenth aspect based on the disaster warning system according to the twelfth aspect, the clock includes a battery configured to, when supply of power is interrupted owing to disconnection of a power supply, supply power instead.

In addition, in the disclosure as in a fifteenth aspect based on the disaster warning system according to the first aspect, the central server sorts a plurality of the control units into arbitrarily-created groups and manages the control units, and the central server simultaneously changes the warning statuses for each of the groups.

In addition, in the disclosure as in a sixteenth aspect based on the disaster warning system according to the first aspect, the control unit includes a preliminary power supply unit configured to, when supply of power is interrupted, supply power instead.

In the disclosure as in a seventeenth aspect based on the disaster warning system according to the second aspect, the control unit includes a preliminary power supply unit configured to, when supply of power is interrupted, supply power instead.

In addition, in the disclosure as in an eighteenth aspect based on the disaster warning system according to the first aspect, the central server determines a failure state of the control unit according to whether or not the control unit has notified the central server of an operation situation of the control unit at each of specific timings.

In the disclosure, the control units are configured to, according to the respective clocks included therein and synchronized with one another in terms of time, access the central server, receive statuses for the control units, and determine whether or not to cause the warning devices to perform announcement operations, at a same time point. Therefore, in the disclosure, the control units can cause the warning devices to perform announcement operations by merely performing an operation for changing the statuses, i.e., warning statuses, for the respective control units in the central server. Specifically, it is unnecessary to sequentially communicate activation instructions to the respective control units, whereby it is unnecessary to take any communication time for such sequential communication. Consequently, the plurality of warning devices can be more swiftly caused to perform announcement operations, whereby evacuation guidance can be prevented from being delayed in a warning reception device activated later in the order of activation. In addition, the plurality of control units access the central server, receive respective warning statuses, and operate the warning devices as appropriate, at a same timing. Consequently, the deviation in operation among the warning devices is decreased, whereby interference between voices in the announcement operations can be decreased.

### BRIEF DESCRIPTION OF THE DRAWINGS

FIG. 1 is a block diagram of a disaster warning system according to the disclosure.

FIG. 2 is a front view showing the appearance of an evacuation guidance signboard pole.

FIG. 3 is an enlarged side view showing an upper part of the appearance of the evacuation guidance signboard pole.

FIG. 4 is a block diagram for explaining a status managed in a central server.

FIG. 5 is a block diagram for explaining a logical configuration of a control board of a control unit.

FIG. 6 is a block diagram for explaining a message database saved in a storage unit of the control unit.

FIG. 7 is a flowchart showing the flow of an operation that is performed by the disaster warning system and that is started when a disaster occurs and is ended when the disaster ceases.

FIG. 8 is a flowchart showing an operation procedure to be performed by the control unit when a disaster occurs.

FIG. 9 is a flowchart showing the flow of management regarding failure of each of control units.

### DETAILED DESCRIPTION OF THE INVENTION

Hereinafter, embodiments of the disclosure will be described in detail with reference to the drawings.

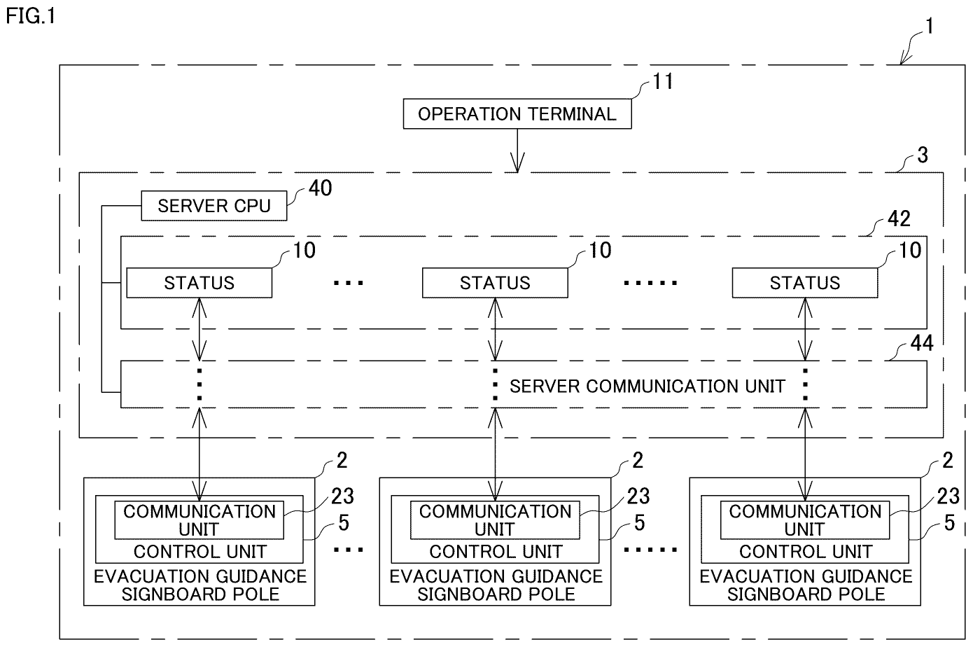

FIG. 1 is a block diagram of a disaster warning system 1 according to the disclosure.

The disaster warning system 1 according to the disclosure has a plurality of evacuation guidance signboard poles 2 arranged at predetermined intervals in an area as an evacuation guidance target, and a central server 3 which manages operations of the evacuation guidance signboard poles 2. Also, for example, an operator such as a person in charge of dealing with disasters in a municipal office operates the disaster warning system 1 by using, as an operation terminal 11, at least one electronic device among a computer, a smartphone, and a tablet which are registered in advance.

The distance between mutually adjacent ones of the plurality of evacuation guidance signboard poles 2 is preferably 50 meters or longer and 2000 meters or shorter and more preferably 100 meters or longer and 1000 meters or shorter.

The disaster warning system 1 may be configured to include the plurality of evacuation guidance signboard poles 2 and the central server 3.

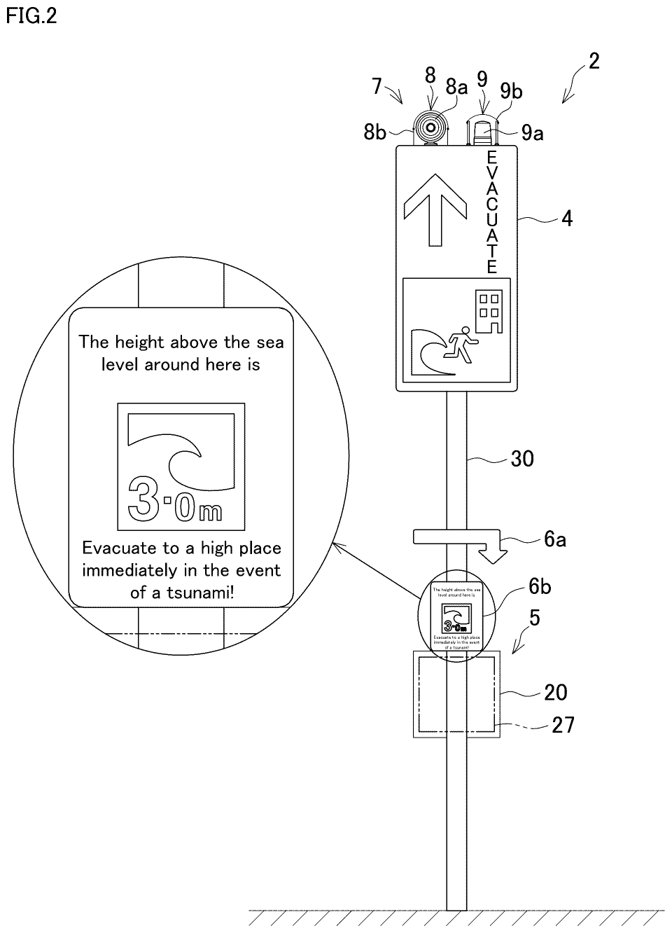

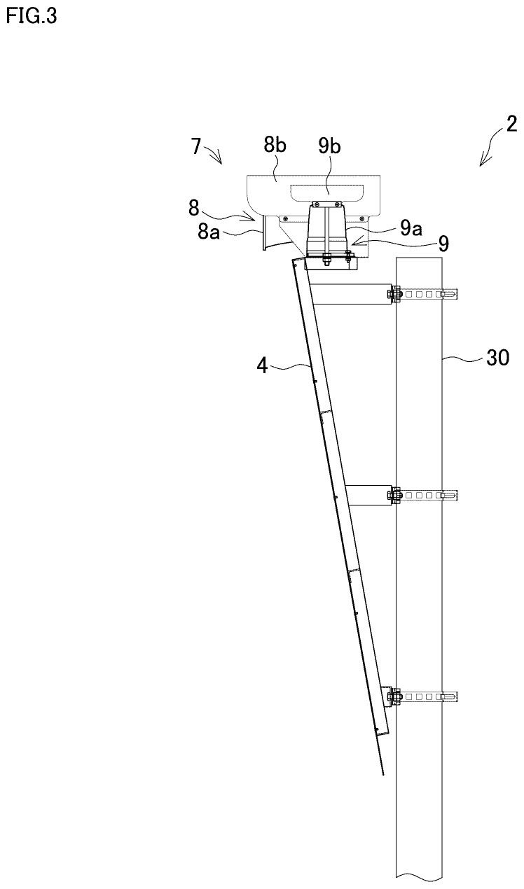

FIG. 2 and FIG. 3 are diagrams for explaining the appearance of any of the evacuation guidance signboard poles 2. FIG. 2 is a front view of the evacuation guidance signboard pole 2. FIG. 3 is an enlarged side view showing an upper structure of the evacuation guidance signboard pole 2.

As shown in FIG. 2, the evacuation guidance signboard pole 2 includes a supporting column 30. The supporting column 30 has an upper part provided with an indication board 4 indicating the location of a refuge and the type of a disaster that can be covered by the refuge, and a warning device 7 disposed on the upper side of the indication board 4. In addition, a control unit 5 which controls the evacuation guidance signboard pole 2 is provided at an intermediate position on the supporting column 30. Furthermore, a first auxiliary indication board 6a and a second auxiliary indication board 6b are provided at intermediate positions on the supporting column 30.

The control unit 5 has a control board 27 and a housing 20. The first auxiliary indication board 6a is an arrow-shaped board indicating at least one height out of an expected inundation height and an inundation height actually reached in the past at the location at which the evacuation guidance signboard pole 2 is installed. The second auxiliary indication board 6b indicates at least one height among the height above the sea level, the expected inundation height, and the inundation height actually reached in the past at the location at which the evacuation guidance signboard pole 2 is installed. The warning device 7 has a loudspeaker 8 and a lamp 9. The loudspeaker 8 has a loudspeaker body 8a and a loudspeaker hood 8b. The lamp 9 has a lamp body 9a and a lamp hood 9b. As the lamp body 9a, for example, a flashlight for letting danger be known in a factory or the like is used.

On the assumption that the evacuation guidance signboard pole 2 is installed in a heavy snowfall zone, the indication board 4 has an angle of depression of about 10 degrees to 20 degrees in order to suppress accumulation of snow thereon.

The central server 3 is an IoT server that is a cloud server, or a server implemented by a physical computer. The central server 3 has a server CPU 40, a server storage unit 42 to be controlled by the server CPU 40, and a server communication unit 44 to be controlled by the server CPU 40. The central server 3 manages the control units 5 provided to the plurality of respective evacuation guidance signboard poles 2.

Specifically, the central server 3 manages statuses 10 corresponding to the respective control units 5. Each of the statuses 10 is stored in the server storage unit 42.

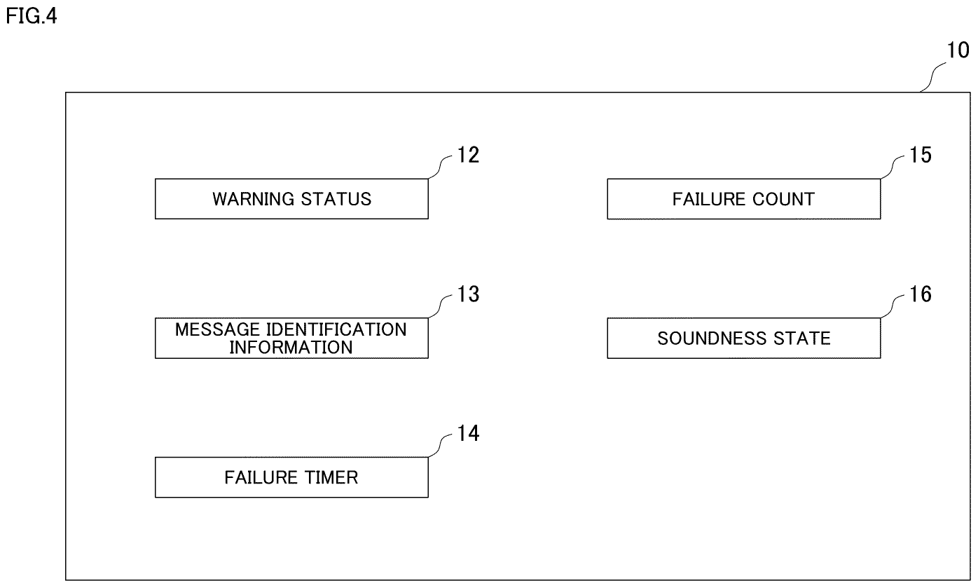

FIG. 4 is a block diagram for explaining an example of the status 10 managed in the central server 3.

The status 10 for each of the control units 5 includes a warning status 12 according to which whether or not to operate the warning device 7 of the evacuation guidance signboard pole 2 having the control unit 5 is determined. In addition, the status 10 includes message identification information 13. The message identification information 13 is determined for each piece of content of messages 50 to be announced by the loudspeaker 8. The message identification information 13 mentioned herein is denoted by a sequential numeral. The message identification information 13 does not have to be a numeral.

The warning status 12 is set to one of activation or stoppage. In a normal state, the warning status 12 is set to stoppage. Meanwhile, when a disaster occurs, the warning statuses 12 for the respective control units 5 corresponding to evacuation guidance signboard poles 2 that are disposed in a district where evacuation guidance is desired to be performed are simultaneously changed from stoppage to activation through an operation of the operation terminal 11. At this time, the operator changes, as necessary, pieces of the message identification information 13 to numbers based on an operation performed by the operator. Subsequently, the control unit 5 of each of the evacuation guidance signboard poles 2 having read information indicating that the warning status 12 of the each of the statuses 10 is activation activates the warning device 7 through an operation by the control unit 5 described below.

Change of the warning status 12 and change of the message identification information 13 may be concurrently performed. Alternatively, one of the warning status 12 or the message identification information 13 may be changed alone.

Furthermore, the status 10 includes a failure timer 14 as a timer for performing management in relation to whether or not the control unit 5 has failed, a failure count 15 which is increased upon expiration of the failure timer 14, and a soundness state 16 indicating whether or not the control unit 5 has failed. Whether or not the control unit 5 has failed is checked by means of the failure timer 14 and the failure count 15 which are linked to a notification of an operation situation of the control unit 5 described below. When the central server 3 determines that any of the control units 5 has failed, the central server 3 changes the soundness state 16 of said control unit 5 to failure.

Also, the central server 3 can sort the plurality of statuses 10 into arbitrarily-created groups and manage the statuses 10. In addition, the server storage unit 42 of the central server 3 can save a plurality of patterns according to which the statuses 10 are sorted into groups. The central server 3 can collectively change the statuses 10 for each of the groups through an operation of the operation terminal 11 by the operator.

The operation terminal 11 is for, by being operated by the operator, changing the statuses 10 for each of the control units 5 in the central server 3 so that the control unit 5 causes the warning device 7 to perform an announcement operation. Furthermore, with use of the operation terminal 11, the operator can establish connection to the central server 3 and can give various instructions to the central server 3 by operating a displayed operation screen.

Specifically, the operator can ascertain the individual statuses 10 for the respective control units 5 with use of the operation terminal 11.

In addition, the operator can change the warning statuses 12 and the pieces of message identification information 13 with use of the operation terminal 11. The warning statuses 12 and the pieces of message identification information 13 may be changed through a predetermined operation or through setting that is performed by the operator himself/herself. All of the warning statuses 12 and the pieces of message identification information 13 can be collectively changed. Alternatively, the warning statuses 12 and the pieces of message identification information 13 can be changed for each of the groups corresponding to respective districts or the like. Still alternatively, a specific one of the warning statuses 12 and the pieces of message identification information 13 can be changed. Also, either the warning statuses 12 or the pieces of message identification information 13 can be changed.

The manner in which the control units 5 are to be sorted into groups can be arbitrarily determined with use of the operation terminal 11 by the operator. In addition, the timing for predetermined communication by the control units 5 described below can be changed through an operation of the operation terminal 11. Moreover, an evacuation guidance signboard pole 2 can be arbitrarily registered to and eliminated from the central server 3 through an operation of the operation terminal 11.

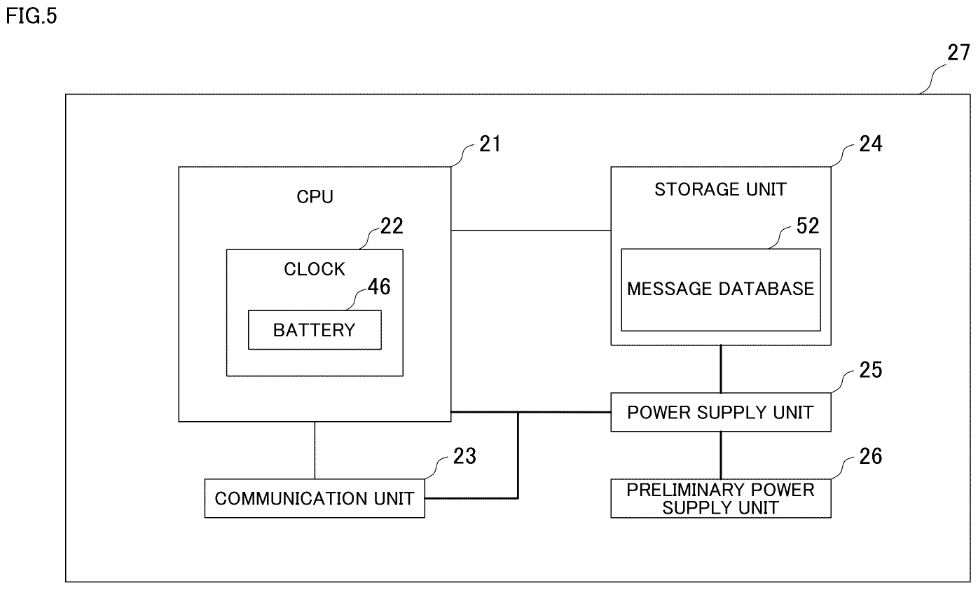

FIG. 5 is a block diagram for explaining a logical configuration of the control board 27 of each of the control units 5.

The control unit 5 includes the housing 20 and the control board 27 accommodated in the housing 20.

The control board 27 is provided with a CPU 21, a communication unit 23, a storage unit 24, a power supply unit 25, and a preliminary power supply unit 26. The CPU 21 controls operations of the control unit 5 and the warning device 7. The communication unit 23 is mounted with a unit for connection to, for example, a commercial mobile phone network for a SIM card-equipped communication device or the like. The storage unit 24 is for storing therein a voice message or the like. The power supply unit 25 supplies power to the control unit 5. The control unit 5 and the central server 3 can bidirectionally communicate with each other via the communication unit 23. The control of the evacuation guidance signboard pole 2 and the communication therebetween may be separately performed by different pieces of hardware.

The CPU 21 ascertains its status 10 received from the central server 3 and controls, according to the details of the status 10, the warning device 7 to perform an operation based on the warning status 12 and the message identification information 13 in the status 10. Moreover, the CPU 21 includes a clock 22 therein. The clock 22 is synchronized to keep accurate time through at least one of communication with a network time protocol (NTP) server via the Internet and access to the central server 3. The clock 22 includes a battery 46 which, when supply of power is interrupted owing to unexpected disconnection of a power supply, supplies power as a preliminary power supply instead.

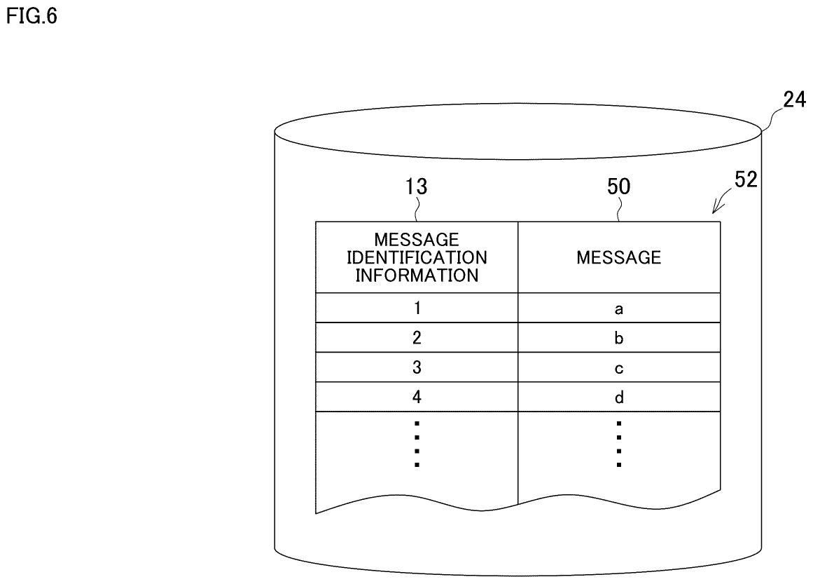

FIG. 6 is a block diagram for explaining a message database 52 saved in the storage unit 24 of the control unit 5.

In the storage unit 24, a message 50 to be emitted from the loudspeaker 8 at the time of an announcement operation performed by the warning device 7 is saved. A plurality of the messages 50 can be saved, and the CPU 21 associates each of the messages 50 with a corresponding one of the pieces of message identification information 13 and manages the associated message 50. For example, “a” as a message 50 is associated with “1” as a piece of message identification information 13, and “b” as a message 50 is associated with “2” as a piece of message identification information 13. That is, in the message database 52 stored in the storage unit 24, each of the pieces of message identification information 13 and the corresponding message 50 are associated with each other. In addition, a message 50 can be newly saved into the storage unit 24 and rewritten through data communication with the central server 3.

A specific method for saving a message 50 into the storage unit 24 by the central server 3 will be described. The central server 3 transmits data of a new message 50 and message identification information 13 corresponding to the message 50 to the communication unit 23 of each of the control units 5 by the server communication unit 44. Then, the CPU 21 saves the message 50 and the message identification information 13 which have been received in the storage unit 24. At this time, when there is a message 50 associated with the same message identification information 13 as the identification information 13 for the received message 50, the CPU 21 overwrites the message 50 with the new message 50 and saves the new message 50.

The power supply unit 25 may be of a type in which power is received from an electric wire or of a type in which power is obtained from a solar panel or the like, or these types may be combined. The preliminary power supply unit 26 is a battery that, when supply of power by the power supply unit 25 is interrupted (as in the case of, for example, a power outage), supplies power as a preliminary power supply instead of the power supply unit 25. The battery as the preliminary power supply unit 26 is charged by the power supply unit 25 while no power outage has occurred.

The control unit 5 performs communication at every predetermined timings, i.e., predetermined communication, by the communication unit 23. In the predetermined communication, the control unit 5 accesses the central server 3 and requests the central server 3 to transmit a status 10, i.e., a warning status 12 and message identification information 13, for the control unit 5. The predetermined timings mentioned herein are timings at each of which the clock 22 included in the CPU 21 indicates a predetermined time point. For example, the predetermined timings are 0 minutes, 10 minutes, 20 minutes, 30 minutes, 40 minutes, and 50 minutes past each hour. When the request to transmit a status 10 is received from the control unit 5, the central server 3 immediately transmits a status 10 to the control unit 5. Then, the CPU 21 determines, on the basis of the warning status 12 of the received status 10, whether or not to operate the warning device 7. The predetermined timings may be changed under each of specific conditions. For example, the predetermined timings may be every 15 minutes past each hour in the ante meridiem (a.m.) period and every 5 minutes past each hour in the post meridiem (p.m.) period. Alternatively, the predetermined timings may be partially or entirely irregular. For example, the predetermined timings may be 0 minutes, 15 minutes, 20 minutes, and 50 minutes past each hour.

In the disaster warning system 1, the plurality of control units 5 perform the predetermined communication to access the central server 3 and acquire statuses 10 including warning statuses 12 and pieces of message identification information 13 and corresponding to the plurality of respective control units 5, and store the statuses 10 in the storage units 24. Hereinafter, a transmission request for a status 10 and reception of a reply thereto are referred to as “detection” of the status 10. Each of the control units 5 performs an operation based on the corresponding warning status 12 and the piece of message identification information 13 which have been stored. Here, the plurality of control units 5 access the central server 3 at a same timing through the predetermined communication with use of the clocks 22 which are included in the respective CPUs 21 and which are each synchronized with the other clocks 22 in terms of time. Therefore, the announcement operations of the warning devices 7 are also performed at the same timing.

In addition, each of the control units 5 notifies the central server 3 of an operation situation of the control unit 5 at each of specific timings. The specific timings may be the same as the timings for ascertaining the status 10 including the warning status 12 and the message identification information 13, i.e., the timings for the predetermined communication, or may be separately set timings. When being notified of an operation situation by any of the control units 5, the central server 3 resets the failure timer 14 and the failure count 15 corresponding to the control unit 5 that has performed the notification. The failure timer 14 measures the time having elapsed from the timing at which the operation situation has been notified of by the control unit 5. The failure timer 14 expires when a timing at which an operation situation is notified of by the control unit 5, i.e., any of the specific timings, has passed. For the specific timings, modifications similar to those for the predetermined timings related to the predetermined communication are applied as appropriate.

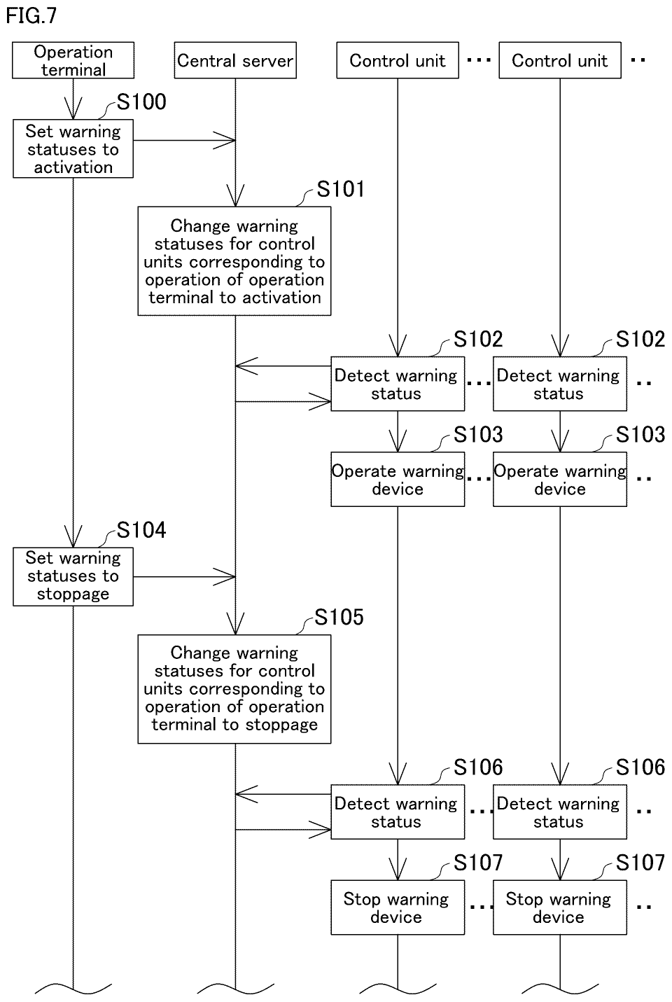

Hereinafter, the flow of an operation that is performed by the disaster warning system 1 according to the embodiment of the disclosure and that is started when a disaster occurs and is ended when the disaster ceases, will be described with reference to the flowchart shown in FIG. 7. In FIG. 7, S represents a step.

When a disaster such as an earthquake or tsunami occurs, a change command and an adjustment command are transmitted to the central server 3 through an operation of the operation terminal 11 by the operator (S100). The change command is for changing warning statuses 12 to activation for the control units 5 belonging to the evacuation guidance signboard poles 2 that are in the entirety or in a predetermined district of the area in which the disaster has occurred. The adjustment command is for adjusting pieces of message identification information 13 for said control units 5 to be consistent with the type of the disaster having occurred. In a case where the pieces of message identification information 13 are already consistent with the type of the disaster having occurred, the command regarding the pieces of message identification information 13 may be omitted.

The central server 3 having received the change command changes the warning statuses 12 for the control units 5 corresponding to the command from the operation terminal 11 from stoppage to activation, and adjusts the pieces of message identification information 13 for said control units 5 (S101).

Next, each of the control units 5 performs the predetermined communication to access the central server 3 and detect a status 10 for the control unit 5 (S102). At this time, the CPU 21 of the control unit 5 stores, in the storage unit 24, the warning status 12 and the message identification information 13 in the status 10.

Then, the control units 5 in which the respective warning statuses 12 stored in the storage units 24 in respective steps S102 are activation cause the warning devices 7 to perform announcement operations based on the respective pieces of message identification information 13 (S103). Specifically, each of the warning devices 7 performs an announcement operation by causing the loudspeaker 8 to reproduce a message 50 corresponding to the message identification information 13 stored in the storage unit 24 in the corresponding step S102, and lighting the lamp 9. The warning device 7 continues the announcement operation until a predetermined reproduction time elapses or until it is ascertained that the warning status 12 has been changed to stoppage. Steps S103 are executed in a synchronized state through the predetermined communication with use of the clocks 22 synchronized with one another.

The lamp 9 may be configured such that the manner of the lighting thereof is changed according to the message identification information 13 or may be configured such that the manner of the lighting thereof is unchanged regardless of the message identification information 13. Similar to the message database 52, a database in which manners of lighting of the lamp are associated with pieces of message identification information 13 may be provided in the storage unit 24, and the manner of the lighting may be controlled in the same manner as in the case of the message 50.

Next, when the disaster ceases and the announcement operation becomes unnecessary, a change command for changing the warning statuses 12 to stoppage is transmitted to the central server 3 through an operation of the operation terminal 11 by the operator (S104).

The central server 3 having received the change command changes the warning statuses 12 for the control units 5 corresponding to the command from the operation terminal 11 from activation to stoppage (S105). At the time of changing the warning statuses 12 corresponding to the respective control units 5, the warning statuses 12 may be collectively changed, changed for each of the groups, or individually changed.

Here, at the time of a disaster warning as well, each of the control units 5 performs the predetermined communication at predetermined timings in the same manner as in a normal state. Consequently, each of the control units 5 accesses the central server 3, detects a status 10 for the control unit 5, and stores the warning status 12 and the message identification information 13 in the storage unit 24 (S106). The predetermined timings in the case of a disaster may differ from the timings in a normal state. For example, the intervals between the predetermined timings in the case of a disaster may be set to be shorter than the intervals in a normal state.

Next, after having ascertained that the respective warning statuses 12 stored in the storage units 24 in respective steps S106 are stoppage, the control units 5 stop the warning devices 7. Consequently, transition to a normal state is performed (S107). Steps S107 are executed in a synchronized state through the predetermined communication with use of the clocks 22 synchronized with one another.

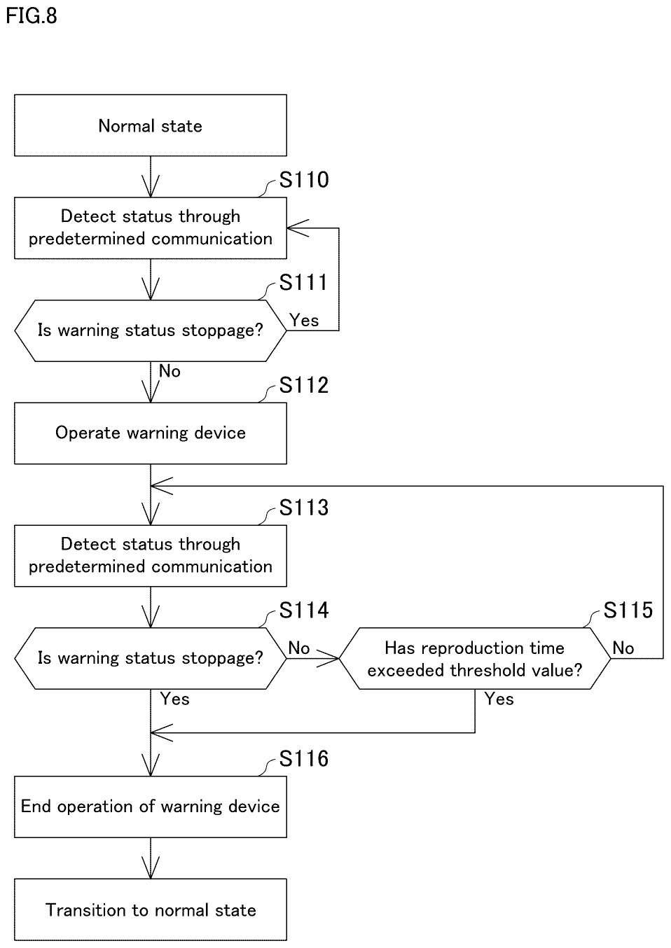

Subsequently, acquisition, by each of the control units 5, of a status 10 for the control unit 5 from the central server 3 and a specific operation by the control unit 5 in the case of a disaster will be described with reference to the flowchart shown in FIG. 8. In FIG. 8, S represents a step.

First, the control unit 5 performs the predetermined communication for accessing the central server 3 at each of the predetermined timings. Consequently, the control unit 5 accesses the central server 3 and detects a status 10 for the control unit 5 (S110). The control unit 5 stores, in the storage unit 24, the detected status 10, i.e., a warning status 12 and message identification information 13, in order to use the status 10 in determination of an operation of the warning device 7 by the CPU 21.

Next, the CPU 21 of the control unit 5 checks whether or not the obtained warning status 12 is stoppage (S111). In a case where the warning status 12 is stoppage (S111: Yes), the control unit 5 returns the process to step S110 and repeats the predetermined communication at each of the predetermined timings.

Meanwhile, in a case where the warning status 12 is activation (S111: No), the control unit 5 operates the warning device 7 (S112). At this time, the CPU 21 causes execution of an announcement operation by causing the loudspeaker 8 of the warning device 7 to reproduce a message 50 that is in the message database 52 and that corresponds to the message identification information 13 stored in step S110, and lighting the lamp 9 of the warning device 7.

Subsequently, the control unit 5 detects a status 10 for the control unit 5 by performing the predetermined communication with respect to the central server 3 again (S113). The control unit 5 performs the predetermined communication at predetermined timings in the same manner as in a normal state also while the warning device 7 is performing the announcement operation. The predetermined timings in the case of a disaster may differ from the timings in a normal state.

Next, the CPU 21 of the control unit 5 checks whether or not the obtained warning status 12 is stoppage (S114). In a case where the warning status 12 is stoppage (S114: Yes), the CPU 21 of the control unit 5 causes the warning device 7 to end the announcement operation (S116) and performs transition to a normal state.

Meanwhile, in a case where the warning status 12 is not stoppage and is still activation (S114: No), it is determined whether or not the time during which the loudspeaker 8 of the warning device 7 is reproducing the message 50 has exceeded, for example, a predetermined threshold value such as 5 hours (S115).

In a case where the reproduction time of the message 50 has not exceeded the threshold value (S115: No), the control unit 5 returns the process to step S113, and then, advances the process to step S114 again. Then, steps S113 to S115 are repeated. Then, in a case where it is determined that the warning status 12 is stoppage in step S114 or in a case where the threshold value for the reproduction time of the message 50 is exceeded in step S115 (S115: Yes), the CPU 21 of the control unit 5 causes the warning device 7 to end the announcement operation (S116) and performs transition to a normal state.

The control unit 5 repeatedly performs steps S113 to S115 also in a case where the control unit 5 becomes unable to access the central server 3 owing to a communication error or the like. At the time point when the reproduction time of the message 50 exceeds the threshold value, the CPU 21 of the control unit 5 causes the warning device 7 to end the announcement operation and performs transition to a normal state.

In the disaster warning system described above, the control units 5 are configured to, according to the respective clocks 22 included therein and synchronized with one another in terms of time, access the central server 3, receive statuses 10 for the control units 5, and determine whether or not to cause the warning devices 7 to perform announcement operations, at a same time point. Therefore, the control units 5 can cause the warning devices 7 to perform announcement operations by merely performing an operation for changing the statuses 10 (warning statuses 12) of control units 5 in the central server 3.

Thus, it is unnecessary to sequentially communicate activation instructions to the respective control units 5, whereby it is unnecessary to take any communication time for such sequential communication. Consequently, the plurality of warning devices 7 can be more swiftly caused to perform announcement operations. Specifically, the activation time of the entirety of the warning system is shortened to perform swift evacuation guidance, and consequently, it is possible to avoid a situation in which evacuation guidance is delayed in a warning reception device activated later in the order of activation.

In addition, the plurality of control units 5 access the central server 3, receive respective warning statuses 12, and operate the warning devices 7 as appropriate, at a same timing. Consequently, the deviation in operation among the warning devices 7 is decreased, whereby interference between voices in the announcement operations performed by the warning devices 7 can be decreased.

In addition, a configuration is employed in which the evacuation guidance signboard poles 2 installed at intervals of several hundreds of meters make announcements with use of messages 50 prestored in the storage units 24 of the control units 5. Consequently, unlike in a method including simultaneously transmitting voices via broadcast waves covering a wide area as in the disaster prevention administrative radio, the operator does not need to possess a special qualification such as a radio operator qualification, and no special console is necessary.

In addition, a configuration is employed in which a message 50 to be emitted from the loudspeaker 8 at the time of an announcement operation performed by each of the warning devices 7 is saved in the storage unit 24 of the control unit 5 in advance instead of being transmitted to the control unit 5. Consequently, influences of congestion in a network for communication and communication restriction in the case of a disaster can be set to be at a minimum level.

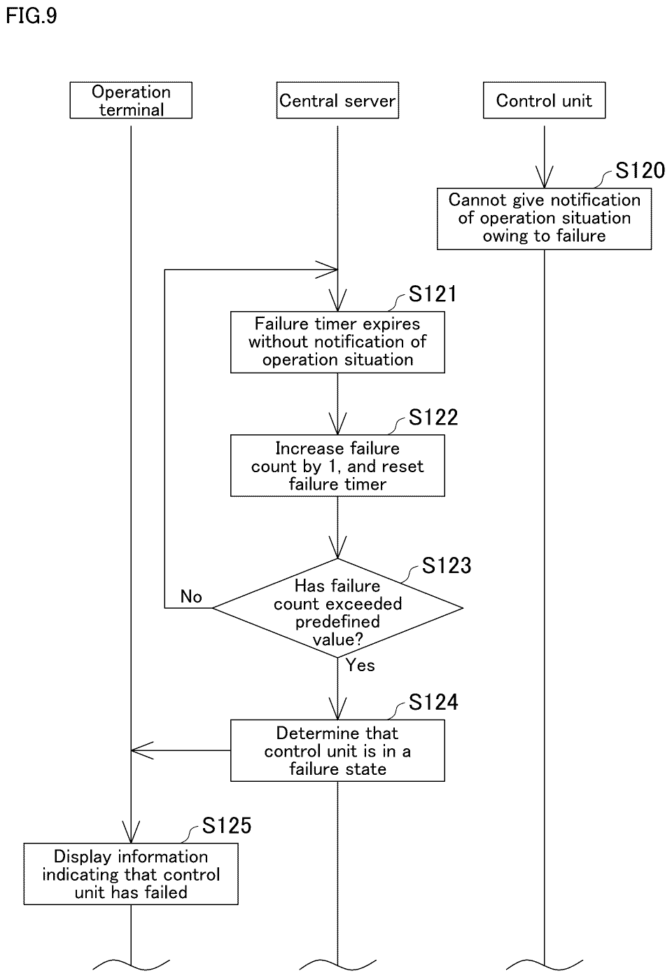

Hereinafter, the flow of management regarding failure of each of the control units 5 in the disaster warning system 1 according to the disclosure will be described with reference to the flowchart in FIG. 9. In FIG. 9, S represents a step.

When any of the control units 5 becomes unable to access the central server 3 owing to failure or the like, the control unit 5 stops notifying the central server 3 of an operation situation of the control unit 5 at each of the specific timings (S120).

Then, the failure timer 14 of the status 10 for the control unit 5 having stopped notification in the central server 3 is not reset by the server CPU 40 and expires (S121).

When the failure timer 14 expires, the server CPU 40 increases the failure count 15 of the status 10 for said control unit 5 by “1” and resets the failure timer 14 (S122).

Then, the server CPU 40 determines whether or not the failure count 15 has exceeded a preset threshold value (S123). In a case where the failure count 15 has not exceeded the threshold value in this step, the operations in steps S121 to S123 are repeated. As the threshold value, for example, an appropriate natural number such as “10” is set.

Then, when the failure count 15 is increased to exceed the threshold value in step S123, the server CPU 40 determines that the control unit 5 is in a failure state (S124). At this time, the server CPU 40 changes, to failure, the soundness state 16 of the status 10 corresponding to the control unit 5 having failed.

Next, the server CPU 40 transmits, to the operation terminal 11, a signal indicating that a specific control unit 5 has failed. When receiving the signal indicating that failure has occurred, the operation terminal 11 gives notification indicating that any of the control units 5 has failed and indicating which of the control units 5 has failed (S125).

Meanwhile, in a case where any of the control units 5 has not given notification of an operation situation owing to a temporary malfunction or the like thereof, and the notification of the operation situation by the control unit 5 is restarted before the failure count 15 resulting from step S122 exceeds the threshold value, the failure count 15 is reset, and the state is returned to a normal state.

With this configuration, the soundness states 16 in the individual statuses 10 of the plurality of respective control units 5 are managed, whereby the control unit 5 having failed can be assuredly and accurately ascertained.

The configuration of the disaster warning system according to the disclosure is not limited in any way to those in the above embodiment, and not only the entire configuration of the disaster warning system but also the configurations related to the evacuation guidance signboard poles and the central server and the like may be optionally changed as necessary.

In the above embodiment, a configuration may be employed in which the central server communicates with each of the control units so as to operate the warning device. In this case, a plurality of servers that communicate with the control units and that may be either physical or virtual servers are prepared. Consequently, the warning devices can be concurrently activated in a distributed manner, whereby the activation time of the entirety of the warning system can be shortened. Alternatively, a protocol suitable for simultaneous communication such as, for example, MQTT is utilized for communication from the central server to the control units regardless of whether a single central server is present or a plurality of central servers are present. Consequently, the activation time of the entirety of the system for the warning devices is shortened, and the deviation in operation among the warning devices is decreased, whereby interference between voices in the announcement operations performed by the warning devices can be decreased.

A configuration may be employed in which, when accessing the central server, each of the control units acquires a reference destination status for referring to a warning device group which is managed by the central server and to which the control unit belongs. In this configuration, the server storage unit stores therein, instead of or in addition to the statuses for the respective control units, group statuses that are statuses of groups corresponding to respective reference destination statuses. Each of the group statuses includes a warning status and message identification information. In this case, the control unit is configured to acquire the group status associated with the acquired reference destination status. Thus, the control unit acquires the warning status and the message identification information, and performs an operation accordingly. The reference destination statuses and the group statuses can be arbitrarily changed through an operation of the operation terminal by the operator, and how the warning devices are sorted into groups can be managed according to the change.

A configuration in which the warning status for each of the control units is changed in association with reception of an emergency broadcast such as the Earthquake Early Warning by the central server may be employed in relation to the configuration in which the operator operates the operation terminal to change the warning status so that a disaster warning is issued. Alternatively, a configuration in which each of the control units receives an emergency broadcast may be employed so that a disaster warning is issued in association with the reception of the emergency broadcast. In this case, regarding the message to be announced, a configuration may be employed in which a message saved in advance is emitted or the emergency broadcast is broadcast.

At least one of the loudspeaker and the lamp may have a function of determining whether or not a normal operation is being performed, and a function of giving a notification of the result of the determination.

A time signal function of periodically activating the loudspeaker and the lamp may be provided in order to check whether or not the loudspeaker and the lamp normally operate, also in a normal state.

A function of randomly reproducing a special voice message may be provided in order to raise curiosity about the evacuation guidance signboard pole.

A mechanism may be provided in which, in relation to whether or not the performance of the battery as the preliminary power supply unit has deteriorated, an instruction is periodically transmitted from the central server so that the degree of the deterioration can be measured.

A heater may be installed in, for example, the housing of the control unit as a measure against low temperature. For example, a thermostat-equipped electric heater is used as the heater.

Meanwhile, the housing of the control unit may have a double structure for shielding the housing from direct sunlight or may have a cooling mechanism such as an air conditioner incorporated therein, as a measure against high temperature.

Another communication manner such as wired communication, wireless LAN, LPWA, or the local 5G may be employed for the communication unit of the control unit.

In order to detect failure of any of the control units, the time having elapsed from the most recent notification may be measured by the failure timer and used as a criterion for determination in relation to failure.

In order to detect failure of any of the control units, a configuration in which the central server communicates with each of the control units and causes the control unit to make a reply so that determination in relation to failure of the control unit is performed according to whether or not there is a reply from the control unit may be employed instead of a configuration in which the control unit notifies the central server of an operation situation of the control unit.

In order to improve visibility at night, content of indication may be written with a phosphorescent material on the indication board of the evacuation guidance signboard pole.

The status may include a lamp status serving as a command for switching between lighting operations of the lamp, e.g., intermittent lighting and constant lighting.

The warning status and the message identification information serving as instructions for operations of the control unit, and the failure timer, the failure count, and the soundness state for performing management regarding failure of the control unit, may be managed as different statuses.

The he warning device may include either the loudspeaker or the lamp alone.

Also, the control unit may control one of the announcement manner of the loudspeaker and the lighting manner of the lamp alone.

The operation terminal may be configured such that authentication by a login ID and a password is required in order for the operator to operate the operation terminal.

A one-time password obtained via email, a smartphone app, a short message service (SMS), or the like may be used instead of or in addition to the above authentication by a login ID and a password.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A disaster warning system comprising a plurality of evacuation guidance signboard poles and a central server configured to manage the plurality of evacuation guidance signboard poles, the disaster warning system being configured to perform evacuation guidance for a disaster victim by the evacuation guidance signboard poles and the central server when a disaster occurs, wherein
each of the plurality of evacuation guidance signboard poles includes
a warning device configured to announce occurrence of the disaster with use of at least one of sound and light, and
a control unit configured to control the evacuation guidance signboard pole,
the control unit of each of the evacuation guidance signboard poles
can control the warning device included in the evacuation guidance signboard pole to which the control unit belongs, and
can communicate with the central server,
the control unit
performs its predetermined communication for accessing the central server at every predetermined timings, and performs the predetermined communication in a state where the evacuation guidance signboard poles are synchronized with one another, and, at the same time,
reads its status managed by the central server,
the status for each of the control units includes a warning status according to which an operation of the warning device is determined,
the warning status for each of the control units makes it possible to arbitrarily set whether to stop or activate the warning device, and,
when the control unit of each of the evacuation guidance signboard poles receives the status through the predetermined communication and the warning status of the received status is activation, the control unit causes the warning device to perform an announcement operation.

2. A disaster warning system comprising an evacuation guidance signboard pole capable of communicating with a central server, the disaster warning system being configured to perform evacuation guidance for a disaster victim by the evacuation guidance signboard pole when a disaster occurs, wherein
the evacuation guidance signboard pole includes
a warning device configured to announce occurrence of the disaster with use of at least one of sound and light, and
a control unit configured to control the evacuation guidance signboard pole,
the control unit can control the warning device included in the evacuation guidance signboard pole and can communicate with the central server configured to give an operation instruction for the control unit,
the control unit performs its predetermined communication for accessing the central server at every predetermined timings, and reads a status managed by the central server,
the status includes a warning status according to which an operation of the warning device is determined,
the warning status makes it possible to arbitrarily set whether to stop or activate the warning device, and,
when the control unit receives the status through the predetermined communication and the warning status is activation, the control unit causes the warning device to perform an announcement operation.

3. The disaster warning system according to claim 1, wherein the evacuation guidance signboard pole includes an indication board indicating, for the disaster victim, a safety place and a disaster that can be covered.

4. The disaster warning system according to claim 2, wherein the evacuation guidance signboard pole includes an indication board indicating, for the disaster victim, a safety place and a disaster that can be covered.

5. The disaster warning system according to claim 1, wherein the warning status is set to stoppage in a normal state and when the disaster has ceased, so that the control unit stops the warning device when the control unit receives the status through the predetermined communication and the warning status is stoppage.

6. The disaster warning system according to claim 2, wherein the warning status is set to stoppage in a normal state and when the disaster has ceased, so that the control unit stops the warning device when the control unit receives the status through the predetermined communication and the warning status is stoppage.

7. The disaster warning system according to claim 1, wherein
the warning device performs announcement with use of sound,
the control unit includes a storage unit in which messages to be reproduced at a time of causing the warning device to perform the announcement operation are saved,
the control unit assigns message identification information to each of the messages and manages the message,
the status further includes the message identification information,
the control unit receives the status through the predetermined communication so as to acquire the warning status and the message identification information, and,
when the acquired warning status is set to activation, the control unit causes the warning device to perform the announcement operation so as to reproduce the message corresponding to the message identification information.

8. The disaster warning system according to claim 2, wherein
the warning device performs announcement with use of sound,
the control unit includes a storage unit in which messages to be reproduced at a time of causing the warning device to perform the announcement operation are saved,
the control unit assigns message identification information to each of the messages and manages the message,
the status further includes the message identification information,
the control unit receives the status through the predetermined communication so as to acquire the warning status and the message identification information, and,
when the acquired warning status is set to activation, the control unit causes the warning device to perform the announcement operation so as to reproduce the message corresponding to the message identification information.

9. The disaster warning system according to claim 7, wherein the message can be subjected to at least one of addition, change, and deletion through communication with the central server.

10. The disaster warning system according to claim 8, wherein the message can be subjected to at least one of addition, change, and deletion through communication with the central server.

11. The disaster warning system according to claim 1, wherein
the control unit includes a clock configured to measure the predetermined timings for the predetermined communication, and
the clock is synchronized to keep accurate time through at least one of communication with an NTP server via the Internet and access to the central server.

12. The disaster warning system according to claim 2, wherein
the control unit includes a clock configured to measure the predetermined timings for the predetermined communication, and
the clock is synchronized to keep accurate time through at least one of communication with an NTP server via the Internet and access to the central server.

13. The disaster warning system according to claim 11, wherein the clock includes a battery configured to, when supply of power is interrupted owing to disconnection of a power supply, supply power instead.

14. The disaster warning system according to claim 12, wherein the clock includes a battery configured to, when supply of power is interrupted owing to disconnection of a power supply, supply power instead.

15. The disaster warning system according to claim 1, wherein
the central server sorts a plurality of the control units into arbitrarily-created groups and manages the control units, and
the central server simultaneously changes the warning statuses for each of the groups.

16. The disaster warning system according to claim 1, wherein the control unit includes a preliminary power supply unit configured to, when supply of power is interrupted, supply power instead.

17. The disaster warning system according to claim 2, wherein the control unit includes a preliminary power supply unit configured to, when supply of power is interrupted, supply power instead.

18. The disaster warning system according to claim 1, wherein the central server determines a failure state of the control unit according to whether or not the control unit has notified the central server of an operation situation of the control unit at each of specific timings.
